(19) United States
(12) Patent Application Publication
(10) Pub. No.: US 2025/0239827 A1
(43) Pub. Date: Jul. 24, 2025

(54) Strip Feeding Hand Tool

(71) Applicant: TE Connectivity Solutions GmbH, Schaffhausen (CH)

(72) Inventor: Chadwick Alan Kerstetter, Middletown, PA (US)

(73) Assignee: TE Connectivity Solutions GmbH, Schaffhausen (CH)

(21) Appl. No.: 18/421,332

(22) Filed: Jan. 24, 2024

Related U.S. Application Data
(60) Provisional application No. 63/624,039, filed on Jan. 23, 2024.

(51) Int. Cl. H01R 43/042

(52) U.S. Cl. CPC H01R 43/042

(57) ABSTRACT

A tool adapted to crimp a contact from a contact strip onto a conductor includes opposing first and second jaws moveable relative to one another. A crimping is mounted to the first jaw, and an anvil is mounted to the second jaw. A shear is movably mounted to the anvil and adapted to receive a contact strip including a plurality of interconnected contacts in an insertion direction.

### CROSS-REFERENCE TO RELATED APPLICATION

This application claims the benefit of U.S. Provisional Patent Application No. 63/624,039, filed on Jan. 23, 2024, the whole disclosure of which is incorporated herein by reference in its entirety.

### FIELD OF THE INVENTION

The present disclosure relates to a crimping tool for a terminal or a contact, and more particularly, to a crimping tool adapted to shear a terminal from a terminal strip, and crimp the terminal onto a conductor.

### BACKGROUND

Electrical terminals are often manufactured in a continuous manner, wherein adjacent terminals are attached to one another by a strip of common material. In some applications, these terminals are manually attached to conductors (e.g., stripped insulated wires) via crimping operations. In order to perform manual terminal crimping, the terminal must be detached from the terminal strip, as well as deformed onto the conductor. Current hand tools do not provide sufficient positioning control of the terminal strip during these operations. This is particularly problematic as the size of terminals continues to decrease. Further, existing hand tools require several components, such as flip locators, which increase their complexity and cost.

Accordingly, improved tools for separating and crimping terminals from a terminal strip onto a conductor are desired.

### SUMMARY

According to an embodiment of the present disclosure, a tool adapted to crimp a contact from a contact strip onto a conductor is provided. The tool includes opposing first and second jaws moveable relative to one another. A crimping is mounted to the first jaw, and an anvil is mounted to the second jaw. A shear is movably mounted to the anvil and adapted to receive a contact strip including a plurality of interconnected contacts in an insertion direction.

### BRIEF DESCRIPTION OF THE DRAWINGS

The invention will now be described by way of example with reference to the accompanying Figures, of which:

FIG. 1 is a perspective view of a strip feeding hand tool according to an embodiment of the present disclosure;

FIG. 2 is another perspective view of the hand tool of FIG. 1 with a contact or terminal strip engaged therewith;

FIG. 3A is a perspective view of a crimping die of the hand tool of the preceding figures;

FIG. 3B is a cross-sectional view of the crimping die of FIG. 3A;

FIG. 4 is a perspective and partial cross-sectional view of the hand tool of FIGS. 1 and 2 with the terminal or contact strip engaged therewith;

FIG. 5 is a perspective view of the hand tool of the preceding figures with a wire or cable arranged therein in a crimping position;

FIG. 6 is a front view of the hand tool shown during a crimping step of operation;

FIG. 7 is a cross-sectional, side perspective view of the hand tool in an intermediate position associated with a first shearing step of operation;

FIG. 8 is a rear perspective view of the hand tool in another intermediate position of operation;

FIG. 9 is a rear perspective view of the hand tool in another intermediate position associated with a second shearing step of operation; and

FIG. 10 is a rear view of the hand tool in another intermediate position as it returns to an initial position.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

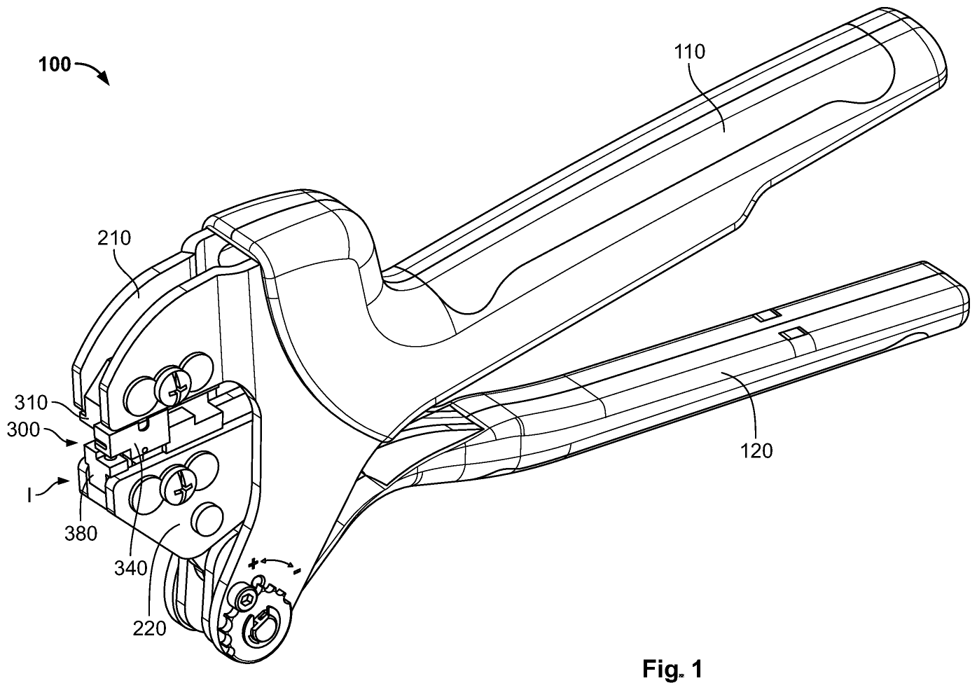

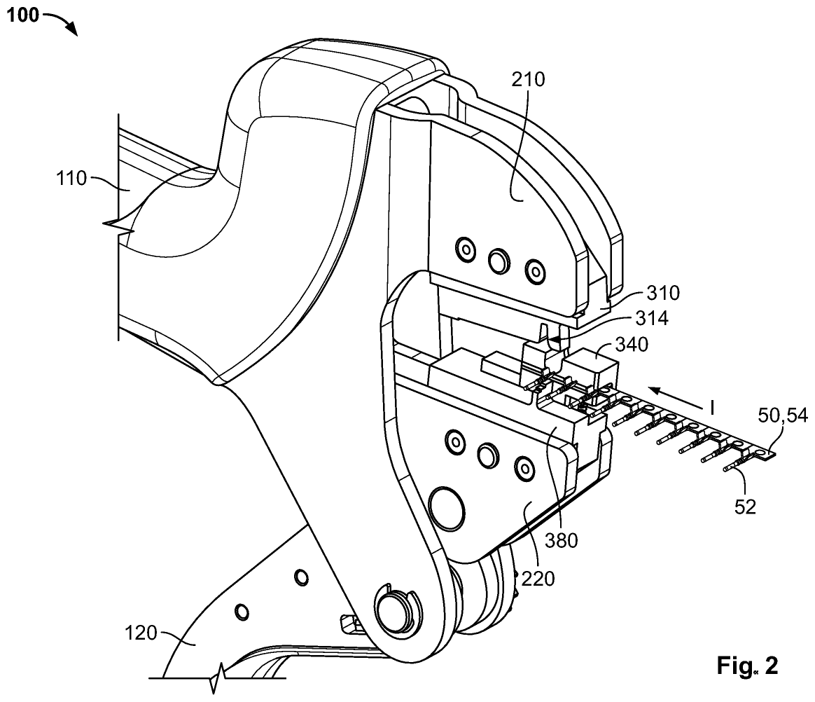

Embodiments of the present disclosure include a crimping tool (e.g., a hand operated crimping tool) adapted to remove a terminal or contact from a strip of terminals (or “terminal strip”) and crimp the removed terminal onto a conductor, such as a wire. The tool comprises opposed handles movably connected to one another. A pair of opposed jaws are attached to respective ones of the handles, and include a floating shear adapted to receive and retain the terminal strip and separate a terminal therefrom. The tool further includes a pair of opposed crimping dies attached to respective ones of the opposed jaws and adapted to crimp the sheared or separated terminal onto the conductor. In one embodiment, the jaws move generally linearly relative to one another as the handles are similarly biased. This motion may be controlled by a ratcheting mechanism arranged between the handles, such that as the handles are moved from an opened position to a closed position, they are fixed in intermediate positions. After the handles have been fully compressed or biased together, and the crimping dies have generally bottomed out (see FIG. 1), the ratchet is released and the handles can return to their opened position, as shown in FIG. 2. This completes a shearing and crimping cycle of the tool.

Referring generally to FIGS. 1 and 2, a tool 100 according to one embodiment of the present disclosure is adapted to receive an exemplary terminal or contact strip 50. The terminal strip 50 includes a plurality of terminals 52 attached to one another via a shared terminal strip section 54 (see FIG. 2). Once received, the tool 100 is further adapted to separate one of the terminals from the strip section 54, crimp the terminal onto a conductor of a cable 10 (see FIG. 5), and segment a remaining portion of the strip section 54.

The tool 100 includes opposed handles 110, 120 connected to respective opposed upper and lower jaws 210, 220. In one embodiment, the lower jaw 220 is adapted to be moved by the handle 120 generally vertically toward the upper jaw 210 as the handle is biased or squeezed toward the handle 110 by a user. As set forth above, relative motion between the handles 110, 120, and thus motion of the jaws 210, 220, may be controlled via an internal ratcheting mechanism. The general construction and overall function of the tool 100 (i.e., the motion of the handles 110, 120 and the jaws 210, 220 and their ratcheting connection), may be similar to existing hand crimping tools, such as the TE Connectivity “PRO-CRIMPER” or “SDE Crimp”. Accordingly, a detailed description of the same is not included herein in the interest of brevity.

The tool 100 further comprises a shearing and crimping assembly or mechanism 300 including a crimper or crimping die 310, a floating shear sub-assembly 340 (also referred to herein as the “shear”) and an anvil 380. In the exemplary embodiment, the crimping die 310 is fixedly attached to the upper jaw 210, and the anvil 380 is fixedly attached to the lower jaw 220. As set forth in greater detail herein, the shear 340 is slidably or otherwise moveably connected to the anvil 380. The shear 340 is adapted to receive the terminal strip 50 in an insertion direction I in a sliding manner (i.e., via a user feeding the terminal strip into the shear sub-assembly in the manner illustrated in FIG. 2).

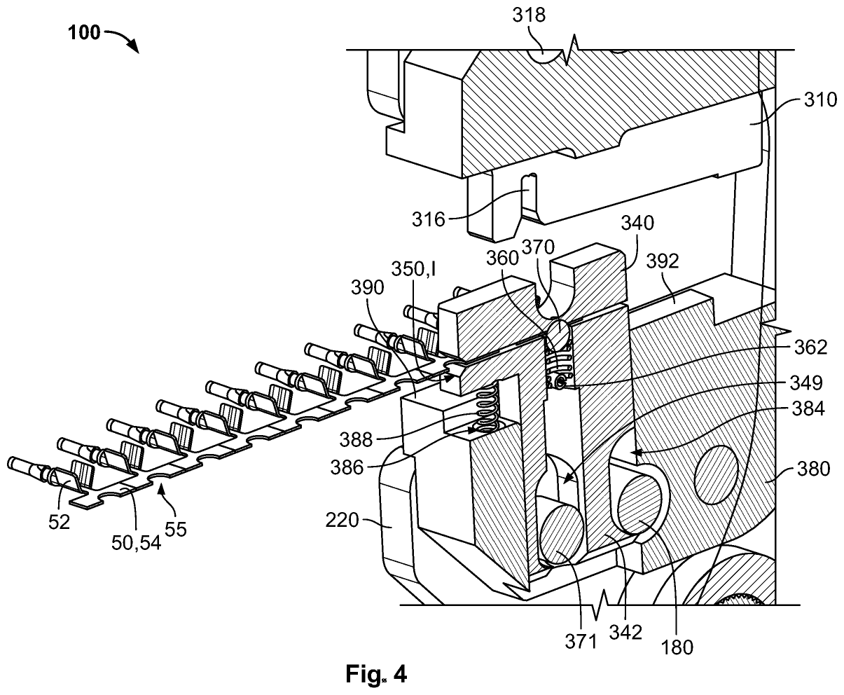

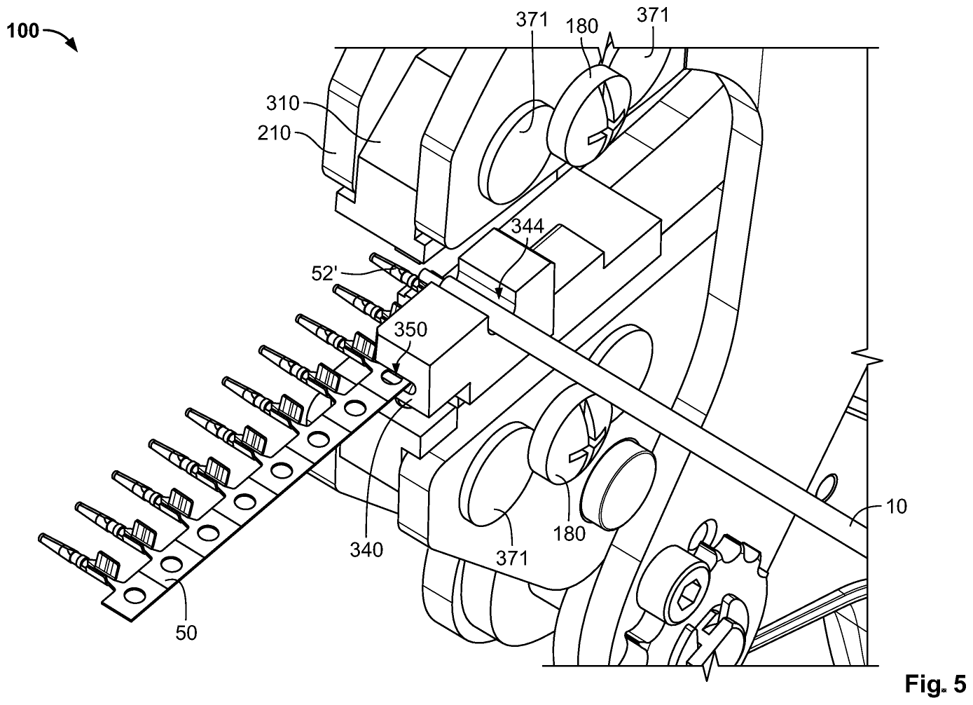

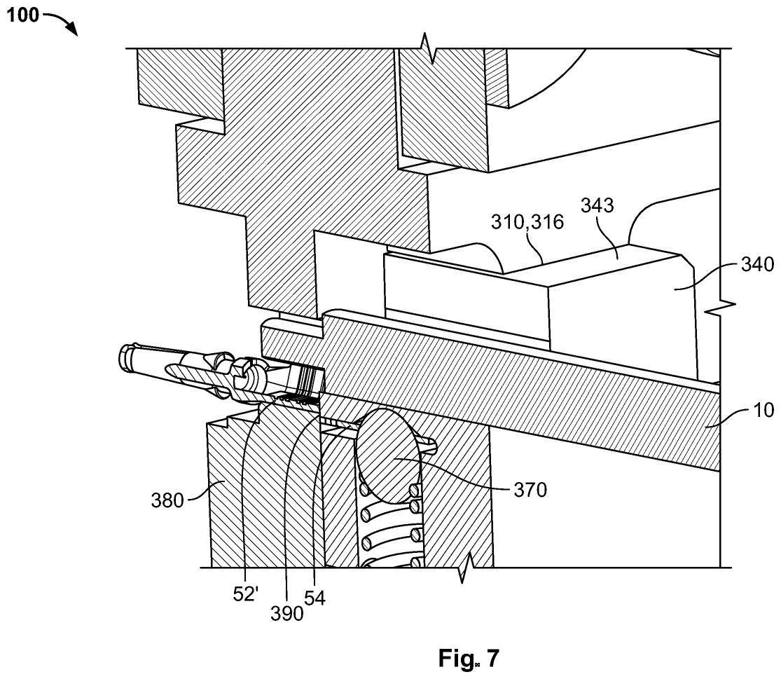

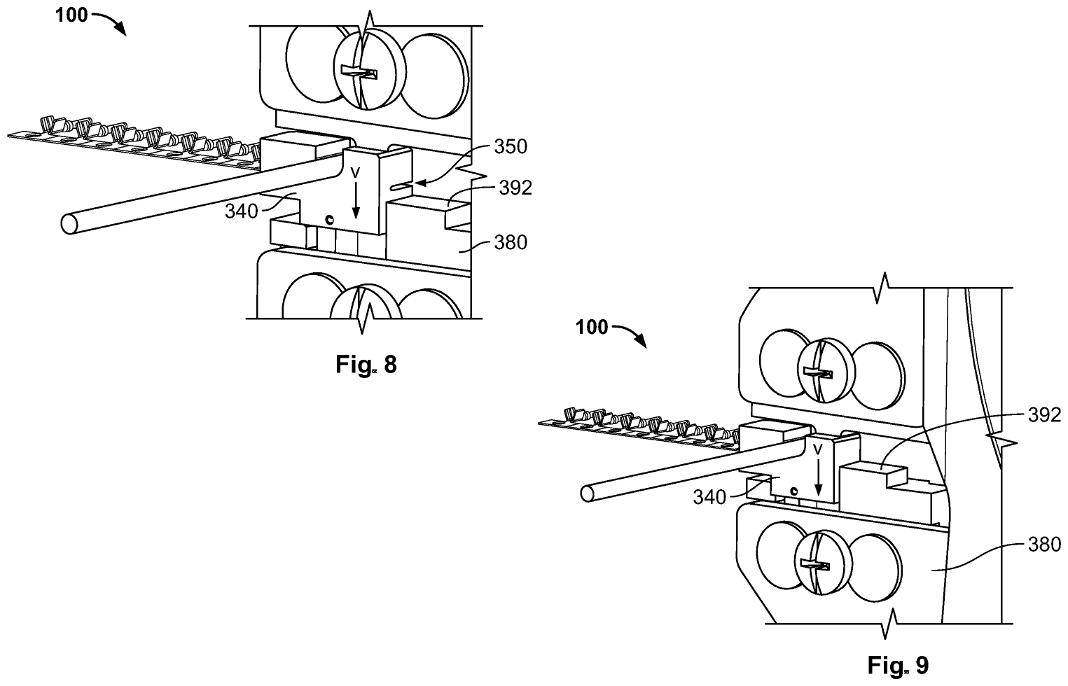

A detailed description of the components of the crimping tool 100 is provide with reference generally to FIGS. 1-10. The crimping die 310 defines a crimping groove 314 adapted to engage with the terminal or contact 52 during crimping, and a driving surface 316 (see FIG. 7). The driving surface 316 opposes a top surface of the shearing 340 and is adapted to make contact therewith during operation of the tool 100. As shown in FIGS. 4 and 5, the crimping die 310 further defines a plurality of mounting features 318, such as mounting holes, enabling it to be removably fixed to the upper jaw 210. This may be achieved via one or more pins or fasteners 371, as set forth in greater detail herein.

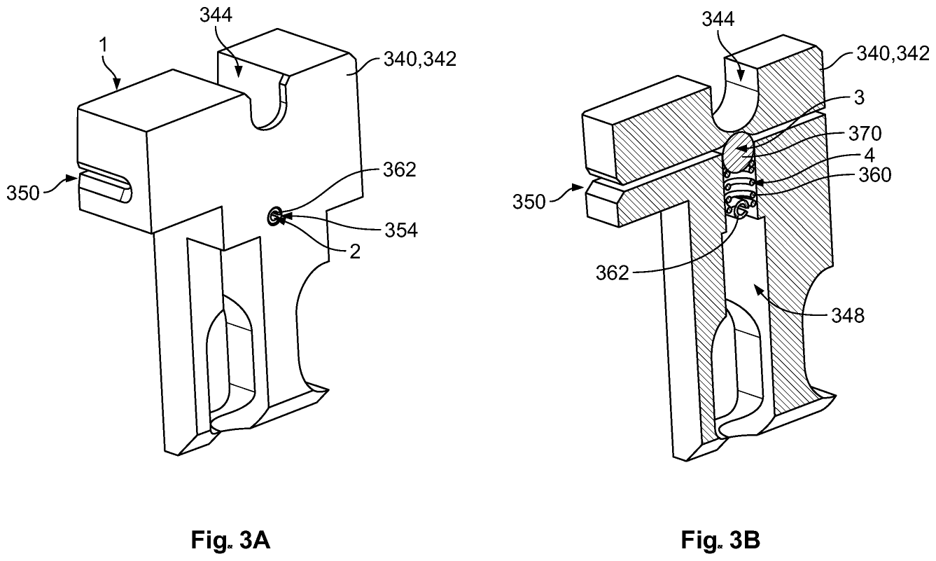

With particular reference to FIGS. 3A, 3B and 4, the shear 340 includes a main body 342 defining a wire or cable receiving slot 344 and a strip receiving slot 350. The main body 342 further defines a first internal bore or opening 348 oriented in a generally vertical direction, and a second internal bore or through hole 354 oriented in a generally horizontal direction, orthogonal to the vertical direction. The first internal bore 348 is in communication with both the strip receiving slot 350 and the second internal bore 354. More specifically, each of the strip receiving slot 350 and the second internal bore 354 extends into and/or through the first internal bore 348. An elastic member, such as a coil spring 360 or other resilient element or material, is arranged within the first internal bore 348 and resiliently supports a strip retainer 370 (e.g., a ball bearing) on a moveable end thereof. The strip retainer 370 is movable within the bore 348 in the vertical direction. A lower end of the coil spring 360 is supported in the vertical direction by, for example, a spring retainer or spring pin 362 arranged into and/or through the second internal bore 354. As least a portion of the strip retainer 370 extends into the strip receiving slot 350. In this way, the strip retainer 370 is adapted to be biased vertically downward by the terminal strip 50 as it is inserted into the slot, compressing the coil spring 360.

Referring to FIG. 4, the anvil 380 defines an opening or a slot 384 in which the shear 340 is moveable or slidably mounted. A pin or fastener 371 holding the anvil 380 to the lower jaw 220 also passes through the shear 340. Specifically, the pin 371 passes through a channel or slot 349 of the shear 340. In this way, the shear 340 is slidable relative to the pin 371, as well as to a corresponding pin-retaining fastener 180 arranged through the lower jaw 220, the anvil 380 and the shear 340.

The anvil 380 further defines a first shearing surface 390 and a second shearing surface 392. The first shearing surface is adapted to shear the terminal 42 from the strip section 54. The second shearing surface 392 is adapted to segment the strip section. The anvil 380 further includes a bore 386 receiving an elastic element 388 (e.g., a coil spring). A moveable end of the elastic element 388 engages with an underside of the shear 340. The elastic element 388 is adapted to bias the shear 340 upward into an initial position, as shown. In the initial position, the terminal strip 50, and more specifically the strip section 54, is insertable into the slot 350 of the shear 340. With reference to FIGS. 4 and 7, with the terminal strip inserted into the shear 340, as the tool 100 is actuated, the pressing surface 316 of the crimping die 310 is adapted to bias the shear 340 against the elastic force of the elastic element 388. This moves the shear 340 downward relative to the anvil 380.

The terminal strip 50, and more specifically the strip section 54, defines a plurality of recesses 55 formed therethrough corresponding in location to each of the contacts or terminals 52 of the strip. The recesses 55 are adapted to engage with, or partially receive, the strip retainer 370 as the strip 50 is inserted into the shear 340. Specifically, the strip section 54 is operative to bias the strip retainer 370 downwardly as it is moved in the insertion direction I. Once the strip retainer 370 and the recess 55 are aligned, the upward bias by the coil spring 360 engages the strip retainer at least partially into and/or through the recess 55, securing the strip 50 relative to the shear 340. This engagement is further operative to align the terminal 52 with the crimping features of the crimping die 310, the anvil 380, and the cable 10 in a direction transverse to the insertion direction I and generally along an axis of elongation of the cable. See FIG. 5.

In further reference to FIG. 5, the tool 100 is shown in the open or initial position after the cable 10 has been inserted therein for termination. More specifically, a free end of the cable 10 has been stripped of its insulation, and inserted into the cable slot 344 of the shear 340. The contact or terminal strip 50 has been inserted into the slot 350 of the shear 340, and positioned such that the cable is axially aligned with one of the terminals or contacts 52′, and is ready to be joined therewith.

The crimping die 310 is also fixed to the upper jaw 110 via pins 371. Each pin 371 is held in the illustrated inserted position via one of the fasteners 180 that is threaded into at least one of the crimping die 310 and/or the upper jaw 210. As set forth above, a similar arrangement is illustrated securing the anvil 380 to the lower jaw 220.

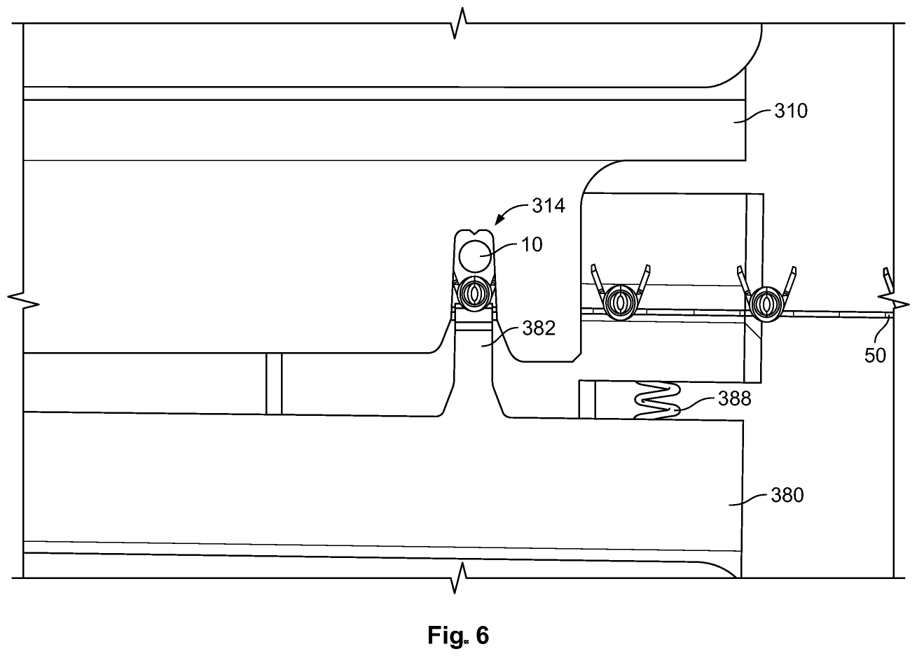

As shown in FIGS. 6 and 7, from the position shown in FIG. 5, a user actuates the tool 100 by bringing the upper and lower handles 110, 120 together. The crimping die 310 and the anvil 380 converge, with a vertically extending crimping protrusion 382 of the anvil 380 entering the crimping opening 314 of the crimping die. Via the strip retainer 370, the terminal or contact 52′ is positioned axially in line with both the crimping opening 314 and the corresponding crimping protrusion 382 at least partially received therein. In this way, the terminal or contact 52′ is securely positioned within the crimping die 310 via the shear 340 and the anvil 380. The cable 10 is arranged above and aligned with the terminal 52′.

With particular reference to FIG. 7, further depression of the crimping die 310 and/or raising of the anvil 380 is operative to bias the driving surface 316 of the crimping die 310 into contact with a corresponding drive surface 343 of the shear 340. As the shear 340 is driven downwardly relative to the anvil 380 and against the elastic bias of the spring 388, the slot 350 passes the first shearing surface 390 of the anvil, and the terminal 52′ is sheared or separated from the strip section 54. In this way, in a first intermediate position of the tool 100, the strip section 54 is removed from a terminal or contact 52′ to be crimped. This is beneficial in that a subsequent crimping operation of the contact 52′ will not be adversely affected by its attachment to the strip section 54.

As can be visualized in FIGS. 7-9, further actuation of the tool 100 is operative to drive the terminal or contact 52′ further into the crimping opening 314 via the crimping protrusion 382, and crimps the terminal or contact 52 onto the exposed end of the cable 10. Once crimped, or simultaneously therewith, the slot 350 passes the second shearing surface 392 in the vertical direction, and a segment of the strip section 54 is cut from a remainder thereof. This manages waste and improves tool efficiency, as the strip section 54 does not have to be manually removed via a separate operation by the user.

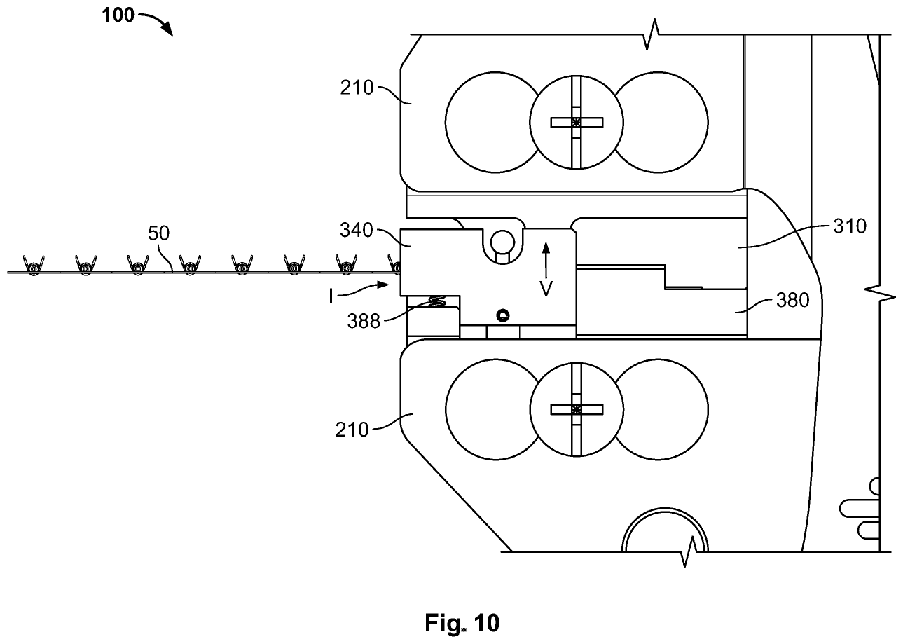

One the segment of the strip section 54 has been sheared or cut, the tool 100 reaches the end of its travel. In one embodiment, this releases the ratcheting mechanism of the tool, permitting the jaws 210, 220 to move apart from one another and a direction toward the first or initial position. As shown in FIG. 10, as the crimping die 310 is raised relative to the lower jaw 220, the shear 340 returns to a resting position under the return bias of the elastic element 388. A user may then advance the terminal strip 50 in the insertion direction I in preparation of another crimping cycle.

While embodiments of the present disclosure have been described in the context of an exemplary hand operated tool, it should be understood that embodiments of the present disclosure may be incorporated into any type of tool (e.g., portable, stationary, powered, etc.) without departing from the scope of the present disclosure. More specifically, tools according to embodiments of the present disclosure may not be hand operated. For example, one or more actuators may be provided to bias the first jaw relative to the second jaw for operating the tool in the above described manner. These actuators may comprise part of a larger automated system including the tool components described herein, or into a powered tool under manual control, by way of non-limiting example.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A tool adapted to crimp a contact from a contact strip onto a conductor, comprising:
a first jaw;
a second jaw moveable relative to the first jaw in an operating direction;
a crimping die fixedly mounted to the first jaw;
an anvil fixedly mounted to the second jaw; and
a shear movably mounted to the anvil and adapted to receive a contact strip including a plurality of interconnected contacts in an insertion direction, and separate one of the plurality of interconnected contacts from the contact strip.

2. The tool of claim 1, wherein the shear defines a first opening adapted to receive the contact strip in the insertion direction.

3. The tool of claim 2, wherein the shear includes a shear retainer adapted to selectively fix the contact strip in a crimping position within the first opening of the shear.

4. The tool of claim 3, wherein the shear retainer is elastically mounted within the shear and extends into the first opening.

5. The tool of claim 2, wherein the anvil defines a first shear surface adapted to separate the one of the plurality of contacts from a shared strip section of the contact strip.

6. The tool of claim 5, wherein the anvil defines a second shear surface adapted to separate a segment of the strip section from a remainder of the strip section.

7. The tool of claim 6, wherein the wherein the first shear surface and the second shear surface are oriented generally orthogonal to one another.

8. The tool of claim 6, wherein the first jaw and the second jaw are movable in the operating direction between a first or initial position wherein the contact strip is insertable into the first opening of the shear, and a second or final position wherein the crimping die and anvil are adapted to crimp the separated one of the plurality of contacts onto the conductor.

9. The tool of claim 8, wherein in a first intermediate position, the first opening of the shear is aligned with the first shear surface of the anvil for separating the contact from a remainder of the contact strip.

10. The tool of claim 9, wherein in a second intermediate position distinct from the first intermediate position, the first opening of the shear is aligned with the second shear surface of the anvil for separating the segment of the strip section from the remainder of the strip section.

11. The tool of claim 10, wherein the tool moves in sequence in the operating direction from the initial position, to the first intermediate position, and to the second intermediate position.

12. The tool of claim 11, wherein in the final position, respective crimping surfaces of the crimping die and the anvil converge for crimping the separated contact.

13. The tool of claim 12, wherein the crimping surfaces include:
one of a crimping recess or a crimping protrusion defined on the crimping die; and
the other one of the crimping recess or the crimping protrusion defined on the anvil, the crimping surfaces adapted to crimp the separated contact onto the conductor.

14. The tool of claim 8, wherein the shear is elastically mounted to the anvil, the shear biased into first position relative to the anvil with the tool in the initial position.

15. The tool of claim 14, wherein the crimping die defines a contact surface engaging with an opposing surface of the shear as the tool is moved from the initial position in the operating direction.

16. The tool of claim 15, wherein the crimping die biases the shear into the first and second intermediate positions as the tool is moved in the operating direction.

17. The tool of claim 1, wherein the shear defines a cable opening adapted to receive a cable in an axial direction.

18. The tool of claim 17, wherein the crimping die defines a contact slot adapted to receive the separated contact, the cable opening and the contact slot aligned with one another in the axial direction of the cable.

19. The tool of claim 18, wherein the insertion direction is generally orthogonal to the axial direction.

20. A hand operated tool adapted to crimp a contact from a contact strip onto a conductor, comprising:
a first jaw;
a second jaw moveable relative to the first jaw in an operating direction;
a pair of handles attached to a respective one of the first and second jaws and adapted to bias the first and second jaws in the operating direction a crimping die fixedly mounted to the first jaw;
an anvil fixedly mounted to the second jaw; and
a shear movably mounted to the anvil and adapted to receive a contact strip including a plurality of interconnected contacts in an insertion direction, and separate one of the plurality of interconnected contacts from the contact strip.
